(19) United States
(12) Patent Application Publication
(10) Pub. No.: US 2020/0339082 A1
(43) Pub. Date: Oct. 29, 2020

(54) VEHICLE BRAKE DEVICE

(71) Applicant: ADVICS CO., LTD., Kariya-shi, Aichi-ken (JP)

(72) Inventors: Takayuki YAMAMOTO, Nagakute-shi, Aichi-ken (JP); Yasuhito ISHIDA, Toyokawa-shi, Aichi-ken (JP); Tatsushi KOBAYASHI, Kariya-shi, Aichi-ken (JP)

(73) Assignee: ADVICS CO., LTD., Kariya-shi, Aichi-ken (JP)

(21) Appl. No.: 16/760,756

(22) PCT Filed: Dec. 6, 2018
(86) PCT No.: PCT/JP2018/044874

§ 371 Date: Apr. 30, 2020

(30) Foreign Application Priority Data
Dec. 7, 2017 (JP) 2017-234805

(51) Int. Cl. B60T 8/172; B60T 17/22; B60T 8/1761

(52) U.S. Cl. CPC B60T 8/172; B60T 8/1761; B60T 17/227; B60T 17/221

(57) ABSTRACT

The present invention is a vehicle brake device in which a brake fluid pressurized by a first pressurizing device and a second pressurizing device is supplied to wheel cylinders, wherein the vehicle brake device is provided with: an acquiring unit that acquires a heating correlation value indicating a heating state of the first pressurizing device; and a control unit that executes a first control that decreases the electric power supplied to the first pressurizing device when the heating correlation value acquired by the acquiring unit is equal to or larger than a prescribed threshold value, and a second control that controls the second pressurizing device to compensate for changes in the wheel pressures, i.e., the fluid pressures inside the wheel cylinders, accompanying the execution of the first control.

### TECHNICAL FIELD

The present invention relates to a vehicle brake device.

### BACKGROUND ART

A vehicle brake device is provided with a holding device that, when holding a braking force, supplies current to hold a fluid pressure. In a case of a hydraulic booster, the holding device corresponds to a normally open electromagnetic valve provided on a flow path for interconnecting a pilot chamber (or a servo chamber) and a reservoir, for example. In a case of an electric booster configured to drive a piston by a ball screw, the holding device corresponds to a motor that is a drive source of the ball screw.

Also, there is a vehicle brake device having an actuator disposed between a master cylinder and a wheel cylinder. There is an actuator that can form a differential pressure between a master pressure and a wheel pressure. This type of actuator can solely pressurize the wheel pressure to execute an antiskid control (ABS control), a side slip prevention control and the like. For example, when the actuator intends to solely hold the wheel pressure, it is necessary to supply current to a differential pressure electromagnetic valve, for example. That is, the actuator has also a holding device. Also, there is an actuator that cannot solely perform the pressurization but can execute the antiskid control (ABS control), a so-called ABS actuator. The ABS actuator is disclosed in PTL 1, for example.

### CITATION LIST

### Patent Literature

PTL 1: JP-A-2008-49897

### SUMMARY OF INVENTION

### Technical Problem

Herein, for example, during a vehicle stop, in a state where a brake pedal is continuously depressed, i.e., a braking force is continuously held, it is necessary to continuously supply current to a pressure adjusting device on an upstream-side or downstream-side. For example, when holding the fluid pressure on the upstream-side, in a case where the pressure adjusting device is a normally open electromagnetic valve, a coil of the electromagnetic valve is continuously in an energization state, and in a case where the pressure adjusting device is a motor, the motor is continuously in the energization state. Due to the continuous energization, the pressure adjusting device generates heat. In order to suppress the heat generation, a method of enlarging the coil to increase heat radiation performance is considered. However, according to this method, the pressure adjusting device is enlarged. The pressure adjusting device generates heat not only due to the holding of the fluid pressure but also due to the supply of electric power. The pressure adjusting device configures a part of a pressurizing device that can pressurize the fluid pressure, in accordance with the supply of electric power, for example.

The present invention has been made in view of the above situations, and an object thereof is to provide a vehicle brake device capable of suppressing heat generation of a device without reducing a braking force.

### Solution to Problem

A vehicle brake device in accordance with a first aspect of the present invention is a vehicle brake device configured to supply a brake fluid pressurized by a first pressurizing device and a second pressurizing device to a wheel cylinder, and includes an acquiring unit configured to acquire a heat generation correlation value indicative of a heat generation state of the first pressurizing device; and a control unit that, when the heat generation correlation value acquired by the acquiring unit is equal to or greater than a prescribed threshold value, executes a first control of decreasing electric power supplied to the first pressurizing device, and a second control of controlling the second pressurizing device so as to compensate for a change in wheel pressure that is a fluid pressure inside the wheel cylinder, accompanying the execution of the first control.

A vehicle brake device in accordance with a second aspect of the present invention includes a pressurizing device including a master cylinder, a normally open pressure adjusting electromagnetic valve disposed on a flow path for interconnecting a drive fluid pressure chamber, in which a drive fluid pressure for driving a master piston is generated, and a reservoir, and a holding electromagnetic valve disposed on a part of the flow path between the pressure adjusting electromagnetic valve and the reservoir, the pressurizing device being configured so that the pressure adjusting electromagnetic valve is closed when holding the drive fluid pressure; an acquiring unit configured to acquire a heat generation correlation value indicative of a heat generation state of the pressure adjusting electromagnetic valve; and a control unit that, when the heat generation correlation value acquired by the acquiring unit is equal to or greater than a prescribed threshold value, executes a first control of decreasing electric power supplied to the pressure adjusting electromagnetic valve, and a second control of controlling the holding electromagnetic valve so as to prevent a change in wheel pressure that is a fluid pressure inside the wheel cylinder, accompanying the execution of the first control. Advantageous Effects of Invention

According to the first aspect of the present invention, in the configuration where the two pressurizing devices are provided, when the heat generation correlation value of the first pressurizing device becomes equal to or greater than the threshold value, the first control is executed, so that the heat generation of the first pressurizing device due to energization is suppressed. Also, the second control is executed for the second pressurizing device, together with the first control, so that the change in wheel pressure is compensated. That is, according to the present invention, it is possible to suppress the heat generation of the first pressurizing device due to supply of electric power without reducing a braking force. Also in the second aspect of the present invention, the heat generation of the pressure adjusting electromagnetic valve is suppressed by the first control, and the change in wheel pressure is prevented/suppressed by the second control, so that the similar effects are achieved.

### BRIEF DESCRIPTION OF DRAWINGS

FIG. 1 is a configuration view of a vehicle brake device of a first embodiment.

FIG. 2 is a sectional view of a regulator of the first embodiment.

FIG. 3 is a configuration view of an actuator of the first embodiment.

FIG. 4 is a time chart for illustrating a heat generation suppression control of the first embodiment.

FIG. 5 is a configuration view of a vehicle brake device of a third embodiment.

FIG. 6 is a configuration view of a pressurizing device of a modified embodiment of the first embodiment.

### DESCRIPTION OF EMBODIMENTS

Hereinbelow, embodiments of the present invention will be described with reference to the drawings. The drawings used for descriptions are conceptual views, and shapes of respective parts may not be strictly exact.

### First Embodiment

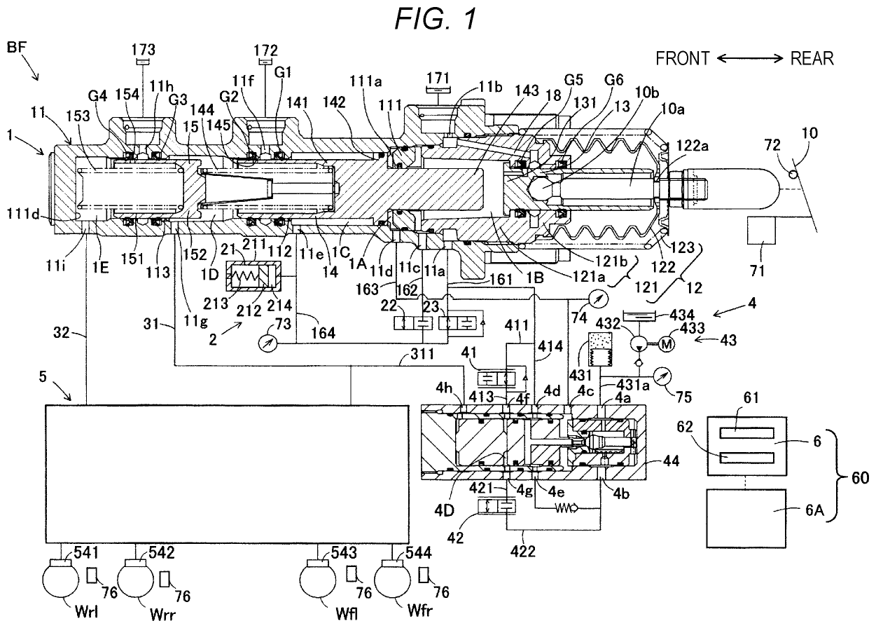

As shown in FIG. 1, a vehicle brake device BF includes a master cylinder 1, a reaction force generation device 2, a first control valve 22, a second control valve 23, a servo pressure generation device (corresponding to “first pressurizing device”) 4, an actuator (corresponding to “second pressurizing device”) 5, wheel cylinders 541 to 544, a variety of sensors 71 to 77, an upstream-side ECU 6, and a downstream-side ECU 6A.

The master cylinder 1 is a part configured to supply a brake fluid to the actuator 5, in accordance with an operation amount on a brake pedal (brake operation member) 10, and has a main cylinder 11, a cover cylinder 12, an input piston 13, a first master piston 14, and a second master piston 15. The brake pedal 10 may be any brake operating means with which a driver can perform a brake operation. In the master cylinder 1 (main cylinder 11), the master pistons 14 and 15 are slidably disposed.

The main cylinder 11 is a substantially cylindrical bottomed housing of which front is closed and rear is opened. An inner wall part 111 protruding in an inwardly directed flange shape is provided in the vicinity of the rear on an inner periphery side of the main cylinder 11. A center of the inner wall part 111 is formed as a through-hole 111b penetrating in a front and rear direction. Also, small-diameter parts 112 (rear) and 113 (front) of which inner diameters are slightly small are provided in front of the inner wall part 111 in the main cylinder 11. That is, the small-diameter parts 112 and 113 protrude in an annular shape inwardly from an inner peripheral surface of the main cylinder 11. In the main cylinder 11, the first master piston 14 is disposed so as to be axially movable in sliding contact with the small-diameter part 112. Likewise, the second master piston 15 is disposed so as to be axially movable in sliding contact with the small-diameter part 113.

The cover cylinder 12 is configured by a substantially cylindrical cylinder part 121, a bellows tube-shaped boot 122, and a cup-shaped compression spring 123. The cylinder part 121 is disposed on a rear end-side of the main cylinder 11, and is coaxially fitted in an opening on a rear side of the main cylinder 11. An inner diameter of a front portion 121a of the cylinder part 121 is larger than an inner diameter of the through-hole 111b of the inner wall part 111. Also, an inner diameter of a rear portion 121b of the cylinder part 121 is smaller than the inner diameter of the front portion 121a.

The dust-proof boot 122 can be expanded and contracted in a bellows tube shape in the front and rear direction, and is attached on its front side so as to contact an opening on a rear end side of the cylinder part 121. A through-hole 122a is formed at a rear center of the boot 122. The compression spring 123 is a coil-shaped urging member disposed around the boot 122, and a front side thereof is in contact with a rear end of the main cylinder 11 and a rear side is radially reduced so as to come close to the through-hole 122a of the boot 122. A rear end of the boot 122 and a rear end of the compression spring 123 are coupled to an operation rod 10a. The compression spring 123 urges rearward the operation rod 10a.

The input piston 13 is a piston configured to slide in the cover cylinder 12 in accordance with an operation of the brake pedal 10. The input piston 13 is a substantially cylindrical bottomed piston having a bottom surface at the front and an opening at the rear. A bottom wall 131 configuring the bottom surface of the input piston 13 has a larger diameter than other part of the input piston 13. The input piston 13 is liquid-tightly disposed so as to be axially slidable in the rear portion 121b of the cylinder part 121, and the bottom wall 131 is disposed on an inner periphery side of the front portion 121b of the cylinder part 121.

In the input piston 13, the operation rod 10a configured to operate in conjunction with the brake pedal 10 is disposed. A pivot 10bat a tip end of the operation rod 10is adapted to push and move forward the input piston 13. A rear end of the operation rod 10a protrudes outward through the opening on the rear side of the input piston 13 and the through-hole 122a of the boot 122, and is connected to the brake pedal 10. When the brake pedal 10 is depressed, the operation rod 10a is advanced while pushing and moving axially the boot 122 and the compression spring 123. The input piston 13 is also advanced in conjunction with the advance of the operation rod 10a.

The first master piston 14 is disposed to be axially slidable on the inner wall part 111 of the main cylinder 11. The first master piston 14 has a pressurizing cylindrical part 141, a flange part 142, and a protrusion 143, which are integrally formed sequentially from the front side. The pressurizing cylindrical part 141 is formed into a substantially cylindrical bottomed shape having an opening at the front, has a gap with the inner peripheral surface of the main cylinder 11, and is in sliding contact with the small-diameter part 112. In an inside space of the pressurizing cylindrical part 141, a coil-shaped urging member 144 is disposed between the pressurizing cylindrical part and the second master piston 15. The urging member 144 urges rearward the first master piston 14. In other words, the first master piston 14 is urged toward a set initial position by the urging member 144.

The flange part 142 has a larger diameter than the pressurizing cylindrical part 141, and is in sliding contact with the inner peripheral surface of the main cylinder 11. The protrusion 143 has a smaller diameter than the flange part 142, and is liquid-tightly disposed to be slidable in the through-hole 111b of the inner wall part 111. A rear end of the protrusion 143 protrudes into an inside space of the cylinder part 121 beyond the through-hole 111a, and is spaced from an inner peripheral surface of the cylinder part 121. A rear end face of the protrusion 143 is spaced from the bottom wall 131 of the input piston 13, and a spacing distance thereof can be varied.

Herein, a “first master chamber 1D” is defined by the inner peripheral surface of the main cylinder 11, a front side of the pressurizing cylindrical part 141 of the first master piston 14, and a rear side of the second master piston 15. Also, a rear chamber is defined at the rear of the first master chamber 1D by the inner peripheral surface (inner peripheral part) of the main cylinder 11, the small-diameter part 112, a front surface of the inner wall part 111, and an outer peripheral surface of the first master piston 14. A front end portion and a rear end portion of the flange part 142 of the first master piston 14 divide the rear chamber into front and rear, so that a “second fluid pressure chamber 1C” is formed on the front side and a “servo chamber 1A” is formed on the rear side. A volume of the second fluid pressure chamber 1C decreases as the first master piston 14 is advanced, and increases as the first master piston 14 is retreated. Also, a “first fluid pressure chamber 1B” is defined by the inner peripheral part of the main cylinder 11, a rear surface of the inner wall part 111, an inner peripheral surface (inner peripheral part) of the front portion 121b of the cylinder part 121, the protrusion 143 (rear end portion) of the first master piston 14, and a front end portion of the input piston 13.

The second master piston 15 is disposed to be axially movable in sliding contact with the small-diameter part 113 on a front side of the first master piston 14 in the main cylinder 11. The second master piston 15 is formed integrally with a tubular pressurizing cylindrical part 151 having an opening at the front, and a bottom wall 152 formed to close a rear side of the pressurizing cylindrical part 151. The bottom wall 152 supports the urging member 144 between the bottom wall and the first master piston 14. In an inside space of the pressurizing cylindrical part 151, a coil-shaped urging member 153 is disposed between the pressurizing cylindrical part and a closed inner bottom surface 111d of the main cylinder 11. The urging member 153 urges rearward the second master piston 15. In other words, the second master piston 15 is urged toward a set initial position by the urging member 153. A “second master chamber 1E” is defined by the inner peripheral surface and the inner bottom surface 111d of the main cylinder 11 and the second master piston 15.

The master cylinder 1 is formed with ports 11a to 11i for communicating an inside and an outside of the master cylinder each other. The port 11a is formed at the rear of the inner wall part 111 of the main cylinder 11. The port 11b is formed to face the port 11a, in an axially similar position to the port 11a. The port 11a and the port 11b communicate with each other via an annular space between the inner peripheral surface of the main cylinder 11 and an outer peripheral surface of the cylinder part 121. The port 11a and the port 11b connect to a pipe 161 and also to a reservoir 171 (low-pressure source).

Also, the port 11b communicates with the first fluid pressure chamber 1B by a passage 18 formed in the cylinder part 121 and the input piston 13. The passage 18 is formed so that it is blocked when the input piston 13 is advanced. Thereby, the first fluid pressure chamber 1B and the reservoir 171 are cut off each other. The port 11c is formed at the rear of the inner wall part 111 and in front of the port 11a, and communicates the first fluid pressure chamber 1B and a pipe 162 each other. The port 11d is formed in front of the port 10c, and communicates the servo chamber 1A and a pipe 163 each other. The port 11e is formed in front of the port 11d, and communicates the second fluid pressure chamber 1C and a pipe 164 each other.

The port 11f is formed between both seal members G1 and G2 of the small-diameter part 112, and communicates a reservoir 172 and the inside of the main cylinder 11 each other. The port 11f communicates with the first master chamber 1D via a passage 145 formed in the first master piston 14. The passage 145 is formed in a position in which the port 11f and the first master chamber 1D are cut off when the first master piston 14 is advanced. The port 11g is formed in front of the port 11f, and communicates the first master chamber 1D and a pipe conduit 31 each other.

The port 11h is formed between both seal members G3 and G4 of the small-diameter part 113, and communicates a reservoir 173 and the inside of the main cylinder 11 each other. The port 11h communicates with the second master chamber 1E via a passage 154 formed in the pressurizing cylindrical part 151 of the second master piston 15. The passage 154 is formed in a position in which the port 11h and the second master chamber 1E are cut off when the second master piston 15 is advanced. The port 11i is formed in front of the port 11h, and communicates the second master chamber 1E and a pipe conduit 32 each other.

Also, a seal member such as an O-ring is appropriately disposed in the master cylinder 1. The seal members G1 and G2 are disposed at the small-diameter part 112, and are in liquid-tight contact with an outer peripheral surface of the first master piston 14. Likewise, the seal members G3 and G4 are disposed at the small-diameter part 113, and are in liquid-tight contact with an outer peripheral surface of the second master piston 15. Also, seal members G5 and G6 are disposed between the input piston 13 and the cylinder part 121.

The stroke sensor 71 is a sensor configured to detect an operation amount (stroke) of the brake pedal 10 made by a driver, and is configured to transmit a detection signal to the upstream-side ECU 6 and the downstream-side ECU 6A. The brake stop switch 72 is a switch configured to detect whether or not a driver's operation is performed on the brake pedal 10 by a binary signal, and is configured to transmit a detection signal to the upstream-side ECU 6.

The reaction force generation device 2 is a device configured to generate a reaction force that opposes an operation force when the brake pedal 10 is operated, and mainly includes a stroke simulator 21. The stroke simulator 21 is configured to generate a reaction fluid pressure in the first fluid pressure chamber 1B and the second fluid pressure chamber 1C, in accordance with an operation of the brake pedal 10. The stroke simulator 21 has a configuration where a piston 212 is slidably fitted in a cylinder 211. The piston 212 is urged rearward by a compression spring 213, and a reaction fluid pressure chamber 214 is formed on a rear surface-side of the piston 212. The reaction fluid pressure chamber 214 is connected to the second fluid pressure chamber 1C via the pipe 164 and the port 11e, and the reaction fluid pressure chamber 214 is connected to the first control valve 22 and the second control valve 23 via the pipe 164.

The first control valve 22 is an electromagnetic valve that is closed in a non-energization state, and opening/closing thereof is controlled by the upstream-side ECU 6. The first control valve 22 is connected between the pipe 164 and the pipe 162. Herein, the pipe 164 communicates with the second fluid pressure chamber 1C via the port 11, and the pipe 162 communicates with the first fluid pressure chamber 1B via the port 11c. Also, when the first control valve 22 is opened, the first fluid pressure chamber 1B is opened, and when the first control valve 22 is closed, the first fluid pressure chamber 1B is closed. Therefore, the pipe 164 and the pipe 162 are provided to communicate the first fluid pressure chamber 1B and the second fluid pressure chamber 1C each other.

The first control valve 22 is closed in the non-energization state. At this time, the first fluid pressure chamber 1B and the second fluid pressure chamber 1C are cut off each other. Thereby, the first fluid pressure chamber 1B is closed, so that there is no place for the brake fluid to flow, and the input piston 13 and the first master piston 14 operate in conjunction with each other while keeping a constant spacing distance. Also, the first control valve 22 is opened in an energization state. At this time, the first fluid pressure chamber 1B and the second fluid pressure chamber 1C communicate with each other. Thereby, a change in volumes of the first fluid pressure chamber 1B and the second fluid pressure chamber 1C as a result of the advance and retreat of the first master piston 14 is absorbed by movement of the brake fluid.

The pressure sensor 73 is a sensor configured to detect reaction fluid pressures in the second fluid pressure chamber 1C and the first fluid pressure chamber 1B, and is connected to the pipe 164. The pressure sensor 73 detects a pressure in the second fluid pressure chamber 1C when the first control valve 22 is in the closed state, and also detects a pressure in the first fluid pressure chamber 1B communicating with the second fluid pressure chamber when the first control valve 22 is in the opened state. The pressure sensor 73 is configured to transmit a detection signal to the upstream-side ECU 6.

The second control valve 23 is an electromagnetic valve that is opened in the non-energization state, and opening/closing thereof is controlled by the upstream-side ECU 6. The second control valve 23 is connected between the pipe 164 and the pipe 161. Herein, the pipe 164 communicates with the second fluid pressure chamber 1C via the port 11e, and the pipe 161 communicates with the reservoir 171 via the port 11a. Therefore, the second control valve 23 does not generate the reaction fluid pressure by communicating the second fluid pressure chamber 1C and the reservoir 171 each other in the non-energization state, and generates the reaction fluid pressure by cutting off the same each other in the energization state.

The servo pressure generation device 4 is a device configured to generate a master pressure in the master chambers 1D and 1E by generating a drive force for driving the master pistons 14 and 15 inside the master cylinder 1. The servo pressure generation device 4 is a so-called hydraulic booster (boosting device), and is a device configured to generate, as the drive force, a pilot pressure (servo pressure) in a first pilot chamber 4D (servo chamber 1A), which will be described later, in accordance with an operation amount of the brake pedal 10, for example. The servo pressure generation device 4 includes a pressure reducing valve 41 (corresponding to “pressure adjusting electromagnetic valve”), a pressure increasing valve 42 (corresponding to “pressure adjusting electromagnetic valve”), a pressure supply unit 43, and a regulator 44. The pressure reducing valve 41 is a normally open electromagnetic valve (normally open valve) that is opened in the non-energization state, and a flow rate (or pressure) thereof is controlled by the upstream-side ECU 6. One side of the pressure reducing valve 41 is connected to the pipe 161 via a pipe 411, and the other side of the pressure reducing valve 41 is connected to a pipe 413. That is, one side of the pressure reducing valve 41 communicates with the reservoir 171 via the pipes 411 and 161 and the ports 11a and 11b. When the pressure reducing valve 41 is closed, the outflow of the brake fluid from the first pilot chamber 4D (which will be described later) is prevented. That is, the pressure reducing valve 41 is closed as current is supplied thereto, thereby operating to hold a fluid pressure in the first pilot chamber 4D (hereinbelow, referred to as “pilot pressure”), a fluid pressure in the servo chamber 1A (hereinbelow, referred to as “servo pressure”) and a fluid pressure in the master chambers 1D and 1E (hereinbelow, referred to as “master pressure”). In the meantime, the reservoir 171 and the reservoir 434 communicate with each other, although not shown. The reservoir 171 and the reservoir 434 may be the same reservoir.

The pressure increasing valve 42 is a normally closed electromagnetic valve (normally closed valve) that is closed in the non-energization state, and a flow rate (or pressure) thereof is controlled by the upstream-side ECU 6. One side of the pressure increasing valve 42 is connected to a pipe 421, and the other side of the pressure increasing valve 42 is connected to a pipe 422. The pressure increasing valve 42 is disposed on a flow path for interconnecting an accumulator 431 and the first pilot chamber 4D, and can be referred to as a pressure increasing unit that is opened as current is supplied thereto, thereby operating to increase the pilot pressure, the servo pressure, and the master pressure. The pressure supply unit 43 is a unit configured to mainly supply a high-pressure brake fluid to the regulator 44. The pressure supply unit 43 includes an accumulator 431, a fluid pressure pump 432, a motor 433, and a reservoir 434.

The accumulator 431 is a tank in which a high-pressure brake fluid is accumulated. The accumulator 431 is connected to the regulator 44 and the fluid pressure pump 432 by a pipe 431a. The fluid pressure pump 432 is driven by the motor 433, and is configured to pneumatically transport the brake fluid stored in the reservoir 434 to the accumulator 431. The pressure sensor 75 provided to the pipe 431b is configured to detect an accumulator fluid pressure in the accumulator 431, and to transmit a detection signal to the upstream-side ECU 6. The accumulator fluid pressure correlates with an accumulation amount of the brake fluid accumulated in the accumulator 431.

When the pressure sensor 75 detects that the accumulator fluid pressure becomes equal to or lower than a prescribed on-pressure, the motor 433 is driven based on a command from the upstream-side ECU 6. Thereby, the fluid pressure pump 432 pneumatically transports the brake fluid to the accumulator 431, thereby recovering the accumulator fluid pressure to a prescribed value or greater. Also, when the pressure sensor 75 detects that the accumulator fluid pressure is lowered to a prescribed off-pressure or less, the motor 433 is stopped based on a command from the upstream-side ECU 6. That is, the on-pressure and the off-pressure of the motor 433 (accumulator 431) are set in the upstream-side ECU 6, and the upstream-side ECU 6 controls the accumulator fluid pressure, based on the detection value of the pressure sensor 75.

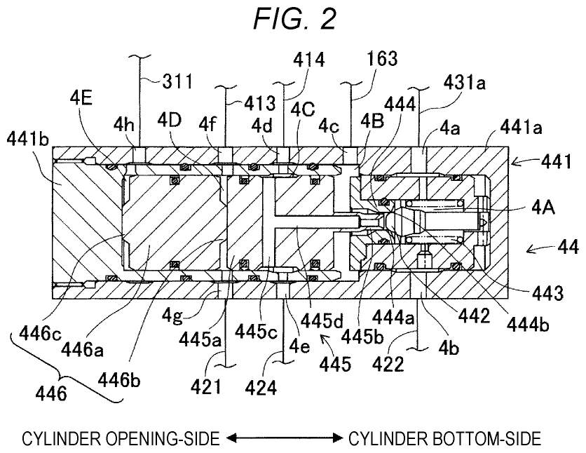

As shown in FIG. 2, the regulator 44 includes a cylinder 441, a ball valve 442, an urging member 443, a valve seat part 444, a control piston 445, and a sub-piston 446. The cylinder 441 includes a cylinder case 441b having a substantially cylindrical bottomed shape having a bottom on one side (a right side in FIG. 2), and a cover member 441b for closing an opening (a left side in FIG. 2) of the cylinder case 441a. The cylinder case 441b is formed with a plurality of ports 4a to 4h for communicating an inside and an outside. The cover member 441b has also a substantially cylindrical bottomed shape, and is formed with ports at respective portions facing the plurality of ports 4a to 4h.

The port 4a connects to the pipe 431a. The port 4b connects to the pipe 422. The port 4c connects to the pipe 163. The pipe 163 interconnects the servo chamber 1A and the port 4c. The port 4d connects to the reservoir 434 via a pipe 414. The port 4e connects to a pipe 424, and also connects to the pipe 422 via a relief valve 423. The port 4f connects to the pipe 413. The port 4g connects to the pipe 421. The port 4h connects to a pipe conduit 311 branched from the pipe conduit 31.

The ball valve 442 is a ball type valve, and is disposed on a bottom-side (hereinbelow, also referred to as ‘cylinder bottom-side’) of the cylinder case 441b inside of the cylinder 441. The urging member 443 is a spring member that urges the ball valve 442 toward an opening-side of the cylinder case 441a (hereinbelow, also referred to as ‘cylinder opening-side’), and is provided on a bottom of the cylinder case 441a. The valve seat part 444 is a wall member provided on an inner peripheral surface of the cylinder case 441a, and demarcates the cylinder opening-side and the cylinder bottom-side. The valve seat part 444 is formed at a center with a through-passage 444a that communicates the demarcated cylinder opening-side and cylinder bottom-side each other. The valve seat part 444 is formed to hold the ball valve 442 from the cylinder opening-side in such a manner that the urged ball valve 442 blocks the through-passage 444a. An opening portion of the through-passage 444a on the cylinder bottom-side is formed with a valve seat surface 444b on which the ball valve 442 is releasably seated (contacted).

A space defined by the ball valve 442, the urging member 443, the valve seat part 444, and the inner peripheral surface of the cylinder case 441b on the cylinder bottom-side is referred to as “first chamber 4A”. The first chamber 4A is filled with the brake fluid, connects to the pipe 431b via the port 4a, and connects to the pipe 422 via the port 4b.

The control piston 445 has a substantially circular column-shaped main body part 445a and a substantially circular column-shaped protrusion 445b having a diameter smaller than the main body part 445a. The main body part 445a is disposed coaxially, liquid-tightly and slidably in an axial direction on the cylinder opening-side of the valve seat part 444, in the cylinder 441. The main body part 445a is urged toward the cylinder opening-side by an urging member (not shown). The main body part 445a is formed at a substantial center in the axial direction of the cylinder with a passage 445c extending in a radial direction (upper and lower direction in FIG. 2) and having both ends opened on a circumferential surface of the main body part 445a. An inner peripheral surface of a part of the cylinder 441, which corresponds to an opening position of the passage 445c, is formed with the port 4d and is recessed. This recessed space is referred to as “third chamber 4C”.

The protrusion 445b protrudes from a center of an end face of the main body part 445a on the cylinder bottom-side toward the cylinder bottom-side. A diameter of the protrusion 445b is smaller than the through-passage 444a of the valve seat part 444. The protrusion 445b is disposed coaxially with the through-passage 444a. A tip end of the protrusion 445b is distant from the ball valve 442 toward the cylinder opening-side by a prescribed gap. The protrusion 445b is formed with a passage 445d extending in the axial direction of the cylinder and opened on a center of an end face of the protrusion 445b on the cylinder bottom-side. The passage 445d extends into the main body part 445a, and connects to the passage 445c.

A space defined by the end face of the main body part 445a on the cylinder bottom-side, an outer peripheral surface of the protrusion 445b, the inner peripheral surface of the cylinder 441, the valve seat part 444, and the ball valve 442 is referred to as “second chamber 4B”. The second chamber 4B communicates with the ports 4d and 4e via the passages 445d and 445c and the third chamber 4C in a state where the protrusion 445b and the ball valve 442 are not in contact with each other.

The sub-piston 446 has a sub-main body part 446a, a first protrusion 446b, and a second protrusion 446c. The sub-main body part 446a has a substantially circular column shape. The sub-main body part 446a is disposed coaxially, liquid-tightly and slidably in the axial direction on the cylinder opening-side of the main body part 445a, in the cylinder 441. Also, an end portion of the sub-piston 446 on the cylinder bottom-side may be provided with a damper mechanism.

The first protrusion 446b has a substantially circular column shape of which a diameter is smaller than the sub-main body part 446a, and protrudes from a center of an end face of the sub-main body part 446a on the cylinder bottom-side. The first protrusion 446b is in contact with an end face of the main body part 445a on the cylinder opening-side. The second protrusion 446c has the same shape as the first protrusion 446b, and protrudes from a center of the end face of the sub-main body part 446a on the cylinder opening-side. The second protrusion 446c is in contact with the cover member 441b.

A space defined by the end face of the sub-main body part 446a on the cylinder bottom-side, an outer peripheral surface of the first protrusion 446b, an end face of the control piston 445 on the cylinder opening-side, and the inner peripheral surface of the cylinder 441 is referred to as “first pilot chamber 4D”. The first pilot chamber 4D communicates with the pressure reducing valve 41 via the port 4f and the pipe 413, and communicates with the pressure increasing valve 42 via the port 4g and the pipe 421.

In the meantime, a space defined by the end face of the sub-main body part 446a on the cylinder opening-side, an outer peripheral surface of the second protrusion 446c, the cover member 441b, and the inner peripheral surface of the cylinder 441 is referred to as “second pilot chamber 4E”. The second pilot chamber 4E communicates with the port 11g via the port 4h and the pipe conduits 311 and 31. Each of the chambers 4A to 4E is filled with the brake fluid. The pressure sensor 74 is a sensor configured to detect a servo pressure that is supplied to the servo chamber 1A, and is connected to the pipe 163. The pressure sensor 74 is configured to transmit a detection signal to the upstream-side ECU 6.

Like this, the regulator 44 includes the control piston 445 that is driven by a difference between a force corresponding to the pilot pressure (the fluid pressure in the first pilot chamber 4D) and a force corresponding to the servo pressure, and is configured so that, when a volume of the first pilot chamber 4D changes and a flow rate of a liquid to flow into and out of the first pilot chamber 4D increases as the control piston 445 moves, an amount of movement of the control piston 445 with respect to a position of the control piston 445 in an equilibrium state where the force corresponding to the pilot pressure and the force corresponding to the servo pressure are balanced is increased to increase a flow rate of the liquid to flow into and out of the servo chamber 1A. That is, the regulator 44 is configured so that a liquid of a flow rate corresponding to the differential pressure between the pilot pressure and the servo pressure is to flow into and out of the servo chamber 1A.

The first pilot chamber 4D or the servo chamber 1A corresponds to “drive fluid pressure chamber”, and the pilot pressure or the servo pressure corresponds to “drive fluid pressure”. Also, the servo pressure generation device 4 can be referred to as a device configured to generate the master pressures in the master chambers 1D and 1E by generating, in the first pilot chamber 4D or the servo chamber 1A, the pilot pressure or the servo pressure for driving the master pistons 14 and 15 in the master cylinder 1.

The regulator 44 is configured so that as a flow rate of the inflow liquid from the accumulator 431 into the first pilot chamber 4D increases, the first pilot chamber 4D is expanded and a flow rate of the inflow liquid from the accumulator 431 into the servo chamber 1A increases, and as a flow rate of the outflow liquid from the first pilot chamber 4D into the reservoir 171 increases, the first pilot chamber 4D is contracted and a flow rate of the outflow liquid from the servo chamber 1A into the reservoir 171 increases. The regulator 44 configured as described above has a hysteresis in which the servo pressure (pilot pressure) fluctuates for a prescribed time period even when the control is shifted from a pressure increasing control or pressure reducing control to a holding control. The prescribed time period is a time period (a time period corresponding to a state) that fluctuates in accordance with a gradient of the servo pressure (pilot pressure).

An amount of the hysteresis is an amount of change in servo pressure that changes still even when the pressure increasing control or pressure reducing control of the servo pressure is over (even when the control is shifted to the holding control). The holding control is a control of closing the pressure reducing valve 41 and the pressure increasing valve 42. For example, in a case where the pressure increasing control, i.e., a state where the control piston 445 pushes the ball valve 442 to communicate the first chamber 4A and the second chamber 4B each other (a state where the control piston 445 is in a pressure increasing position) is switched to the holding control, i.e., a state where the pressure reducing valve 41 and the pressure increasing valve 42 are closed to close the first pilot chamber 4D, when the pressure increasing state continues until the control piston 445 retreats from the pressure increasing position to cut off the first chamber 4A and the second chamber 4B, the hysteresis occurs. As the gradient of the servo pressure, i.e., the gradient of the pilot pressure becomes greater, the control piston 445 is further advanced, the time for retreat after switching to the holding control becomes longer, and an amount of the hysteresis increases. In contrast, the smaller the gradient of the servo pressure is, the smaller the amount of the hysteresis is.

Also, a dead zone for a target servo pressure is set in the upstream-side ECU 6. The dead zone is set on a positive side and a negative side with respect to the target servo pressure. The upstream-side ECU 6 switches the brake control to the holding control when the servo pressure becomes actually a value within a range of the dead zone. That is, when performing the brake control, the upstream-side ECU 6 recognizes that the servo pressure reaches substantially the target servo pressure if the servo pressure actually enters the range of the dead zone (dead zone region). By setting the dead zone, it is possible to suppress hunting in fluid pressure control, as compared to a configuration where the target servo pressure is set as one point.

The actuator 5 is disposed between the first master chamber 1D and second master chamber 1E in which the master pressure is generated and the wheel cylinders 541 to 544. The actuator 5 and the first master chamber 1D are interconnected by the pipe conduit 31, and the actuator 5 and the second master chamber 1E are interconnected by the pipe conduit 32. The actuator 5 is a device configured to adjust fluid pressures (wheel pressures) in the wheel cylinders 541 to 544, in accordance with an instruction from the downstream-side ECU 6A. The actuator 5 is configured to execute a pressurization control of further pressurizing the brake fluid from the master pressure, the pressure reducing control, and the holding control, in accordance with a command from the downstream-side ECU 6A. The actuator 5 is configured to combine the controls to execute an antiskid control (ABS control), a side slip prevention control (ESC control) and the like, based on a command from the downstream-side ECU 6A.

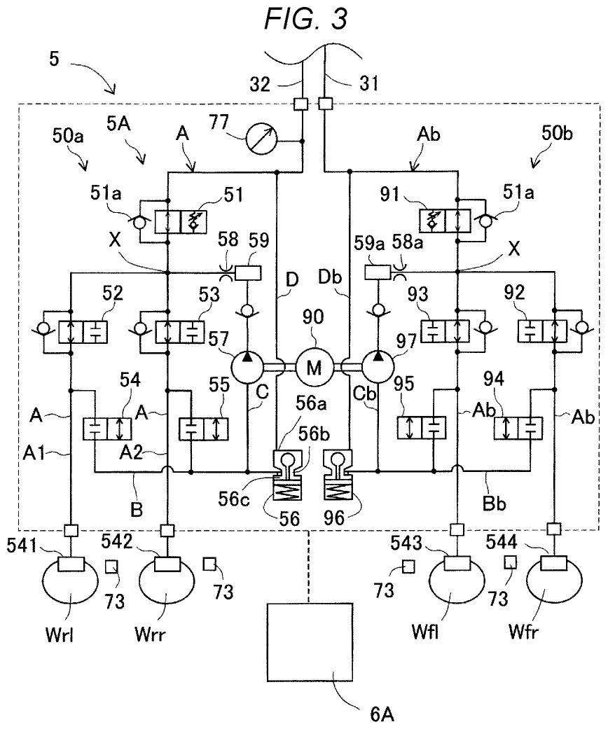

Specifically, as shown in FIG. 3, the actuator 5 includes a hydraulic circuit 5A, and an electric motor 90. The hydraulic circuit 5A includes a first pipe system 50a, and a second pipe system 50b. The first pipe system 50a is a system configured to control fluid pressures (wheel pressures) that are applied to rear wheels Wrl and Wrr. The second pipe system 50bis a system configured to control fluid pressures (wheel pressures) that are applied to front wheels Wfl and Wfr. Also, each of the wheels W is provided with a wheel speed sensor 76. In the first embodiment, a front and rear pipe is adopted.

The first pipe system 50a includes a main pipe conduit A, a differential pressure electromagnetic valve 51, pressure increasing valves 52 and 53, a pressure reducing pipe conduit B, pressure reducing valves 54 and 55, a pressure adjusting reservoir 56, a reflux pipe conduit C, a pump 57, an auxiliary pipe conduit D, an orifice part 58, and a damper part 59. In descriptions, the term “pipe conduit” can be replaced with a fluid pressure path, a flow path, an oil path, a passage, a pipe or the like.

The main pipe conduit A is a pipe conduit for interconnecting the pipe conduit 32 and the wheel cylinders 541 and 542. The differential pressure electromagnetic valve 51 is an electromagnetic valve (differential pressure control valve) provided on the main pipe conduit A and configured to control the main pipe conduit A to a communication state and a differential pressure state. The differential pressure state is a state in which a flow path is restricted by a valve, and can be referred to as a throttled state. The differential pressure electromagnetic valve 51 is configured to control a differential pressure (hereinbelow, also referred to as “first differential pressure”) between a fluid pressure on the master cylinder 1-side and a fluid pressure on the wheel cylinders 541 and 542-side with respect to the differential pressure electromagnetic valve, in accordance with control current based on an instruction from the downstream-side ECU 6A. In other words, the differential pressure electromagnetic valve 51 is configured to control a differential pressure between a fluid pressure of a part of the main pipe conduit A on the master cylinder 1-side and a fluid pressure of a part of the main pipe conduit A on the wheel cylinders 541 and 542-side. The differential pressure electromagnetic valve 51 can be referred to as an electromagnetic valve capable of controlling the differential pressure to be higher as a value of supplied current is greater.

The differential pressure electromagnetic valve 51 is a normally open type that is in the communication state in the non-energization state. As the control current that is applied to the differential pressure electromagnetic valve 51 becomes greater, the first differential pressure becomes higher. When the pump 57 is driven in a state where the differential pressure electromagnetic valve 51 is controlled to the differential pressure state, the fluid pressure on the wheel cylinders 541 and 542-side becomes higher than the fluid pressure on the master cylinder 1-side, in accordance with the control current. The differential pressure electromagnetic valve 51 is provided with a check valve 51a. The main pipe conduit A is branched to two pipe conduits A1 and A2 at a branch point X on a downstream-side of the differential pressure electromagnetic valve 51 so as to correspond to the wheel cylinders 541 and 542.

The pressure increasing valves 52 and 53 are each an electromagnetic valve that is opened/closed in accordance with an instruction from the downstream-side ECU 6A, and is a normally open electromagnetic valve that is opened (communication state) in the non-energization state. The pressure increasing valve 52 is disposed on the pipe conduit A1, and the pressure increasing valve 53 is disposed on the pipe conduit A2. The pressure increasing valves 52 and 53 are not energized and are opened to communicate the wheel cylinders 541 to 544 and the branch point X each other during the pressure increasing control, and are energized and closed to cut off the wheel cylinders 541 to 544 and the branch point X each other during the holding control and the pressure reducing control.

The pressure reducing pipe conduit B is a pipe conduit for interconnecting a point on the pipe conduit A1 between the pressure increasing valve 52 and the wheel cylinder 541; 542 and the pressure adjusting reservoir 56, and interconnecting a point on the pipe conduit A2 between the pressure increasing valve 53 and the wheel cylinder 541; 542 and the pressure adjusting reservoir 56. The pressure reducing valves 54 and 55 are each an electromagnetic valve that is opened/closed in accordance with an instruction from the downstream-side ECU 6A, and are each a normally closed electromagnetic valve that is closed (cut off) in the non-energization state. The pressure reducing valve 54 is disposed on the pressure reducing pipe conduit B on the wheel cylinders 541 and 542-side. The pressure reducing valve 55 is disposed on the pressure reducing pipe conduit B on the wheel cylinders 541 and 542-side. The pressure reducing valves 54 and 55 are energized and opened mainly during the pressure reducing control, thereby communicating the wheel cylinders 541 and 542 and the pressure adjusting reservoir 56 each other via the pressure reducing pipe conduit B. The pressure adjusting reservoir 56 is a reservoir including a cylinder, a piston, and an urging member.

The reflux pipe conduit C is a pipe conduit for interconnecting the pressure reducing pipe conduit B (or the pressure adjusting reservoir 56) and a point (here, the branch point X) on the main pipe conduit A between the differential pressure electromagnetic valve 51 and the pressure increasing valves 52 and 53. The pump 57 is provided on the reflux pipe conduit C so that a discharge port thereof is disposed on the branch point X-side and a suction port thereof is disposed on the pressure adjusting reservoir 56-side. The pump 57 is a gear type electric pump that is driven by the electric motor 90. The pump 57 is configured to cause the brake fluid to flow from the pressure adjusting reservoir 56 toward the master cylinder 1-side or the wheel cylinders 541 and 542-side via the reflux pipe conduit C. Also, upon the antiskid control, for example, the pump 57 pumps up the brake fluid in the wheel cylinders 541 and 542 and returns the same to the master cylinder 1 via the pressure reducing valves 54 and 55 in the opened state. Like this, the pump 57 is disposed between the master cylinder 1 and the wheel cylinders 541 and 542, and can discharge the brake fluid in the wheel cylinders 541 and 542 to the outside of the wheel cylinders 541 and 542.

The pump 57 is configured to repeat a discharge process of discharging the brake fluid and a suction process of sucking the brake fluid. That is, when the pump 57 is driven by the electric motor 90, the pump 57 repeatedly executes alternately the discharge process and the suction process. In the discharge process, the brake fluid sucked from the pressure adjusting reservoir 56 in the suction process is supplied to the branch point X. The electric motor 90 is energized and driven via a relay (not shown), in accordance with an instruction from the downstream-side ECU 6A. The pump 57 and the electric motor 90 may also be collectively referred to as an electric pump.

The orifice part 58 is a throttle-shaped part (so-called orifice) provided between the pump 57 on the reflux pipe conduit C and the branch point X. The damper part 59 is a damper (damper mechanism) connected between the pump 57 on the reflux pipe conduit C and the orifice part 58. The damper part 59 is configured to absorb/discharge the brake fluid, in accordance with pulsation of the brake fluid in the reflux pipe conduit C. The orifice part 58 and the damper part 59 may be referred to as a pulsation reducing mechanism configured to reduce (attenuate, absorb) the pulsation.

The auxiliary pipe conduit D is a pipe conduit for interconnecting a pressure adjusting hole 56a of the pressure adjusting reservoir 56 and a further upstream side (or the master cylinder 1) than the differential pressure electromagnetic valve 51 on the main pipe conduit A. The pressure adjusting reservoir 56 is configured so that a valve hole 56b is closed as an inflow amount of the brake fluid into the pressure adjusting hole 56a increases as a result of an increase in stroke. A reservoir chamber 56c is formed on the valve hole 56b on the pipe conduits B and C-side.

When the pump 57 is driven, the brake fluid in the pressure adjusting reservoir 56 or the master cylinder 1 is discharged to apart (branch point X) between the differential pressure electromagnetic valve 51 and the pressure increasing valves 52 and 53 on the main pipe conduit A through the reflux pipe conduit C. Then, the wheel pressures are pressurized, in accordance with the control states of the differential pressure electromagnetic valve 51 and the pressure increasing valves 52 and 53. In this way, in the actuator 5, the pressurization control is executed by the drive of the pump 57 and the controls of the diverse valves. That is, the actuator 5 is configured to pressurize the wheel pressures. In the meantime, a part between the differential pressure electromagnetic valve 51 on the main pipe conduit A and the master cylinder 1 is provided with a pressure sensor 77 configured to detect a fluid pressure (master pressure) of the part. The pressure sensor 77 is configured to transmit a detection result to the upstream-side ECU 6 and the downstream-side ECU 6A.

The second pipe system 50bhas a similar configuration to that of the first pipe system 50a, and is a system configured to adjust the fluid pressures in the wheel cylinders 543 and 544 of the front wheels Wfl and Wfr. The second pipe system 50bincludes a main pipe conduit Ab corresponding to the main pipe conduit A and configured to interconnect the pipe conduit 31 and the wheel cylinders 543 and 544, a differential pressure electromagnetic valve 91 corresponding to the differential pressure electromagnetic valve 51, pressure increasing valves 92 and 93 corresponding to the pressure increasing valves 52 and 53, a pressure reducing pipe conduit Bb corresponding to the pressure reducing pipe conduit B, pressure reducing valves 94 and 95 corresponding to the pressure reducing valves 54 and 55, a pressure adjusting reservoir 96 corresponding to the pressure adjusting reservoir 56, a reflux pipe conduit Cb corresponding to the reflux pipe conduit C, a pump 97 corresponding to the pump 57, an auxiliary pipe conduit Db corresponding to the auxiliary pipe conduit D, an orifice part 58a corresponding to the orifice part 58, and a damper part 59a corresponding to the damper part 59. The descriptions of the detailed configurations of the second pipe system 50bare omitted because it is possible to refer to the descriptions of the first pipe system 50a. Also, in descriptions below, the respective parts of the actuator 5 are described using the reference signs of the first pipe system 50a, and the reference signs of the second pipe system 50bare omitted. Like this, the actuator 5 includes the normally open differential pressure electromagnetic valves 51 and 91 configured to adjust the differential pressure between the output fluid pressure (master pressure) of the servo pressure generation device 4 and the wheel pressures, and the pumps 57 and 97 configured to discharge the brake fluid between the servo pressure generation device 4 and the differential pressure electromagnetic valves 51 and 91 to parts between the differential pressure electromagnetic valves 51 and 91 and the wheel cylinders 541 to 544.

The upstream-side ECU 6 and the downstream-side ECU 6A are electronic control units (ECUs) each having a CPU, a memory and the like. The upstream-side ECU 6 is an ECU configured to execute a control on the servo pressure generation device 4, based on a target wheel pressure (or a target deceleration) that is a target value of the wheel pressure. The upstream-side ECU 6 is configured to execute the pressure increasing control (pressurization control), the pressure reducing control or the holding control on the servo pressure generation device 4, based on the target wheel pressure. In the pressure increasing control, the pressure increasing valve 42 is in the opened state and the pressure reducing valve 41 is in the closed state. In the pressure reducing control, the pressure increasing valve 42 is in the closed state and the pressure reducing valve 41 is in the opened state. In the holding control, the pressure increasing valve 42 and the pressure reducing valve 41 are in the closed state. In this way, the servo pressure generation device 4 is configured so that electric power is consumed when holding the fluid pressure (master pressure) that is supplied to the wheel cylinders 541 to 544. The servo pressure generation device 4 includes the master cylinder 1, and the normally open pressure reducing valve 41 configured to adjust inflow/outflow of the brake fluid into/out of the drive fluid pressure chamber (the first pilot chamber 4D or the servo chamber 1A) configured to generate the drive fluid pressure (the pilot pressure or the servo pressure) for driving the master pistons 14 and 15, and is configured so that the pressure reducing valve 41 is closed when holding the drive fluid pressure. Also, as a device configured to output the pressurized brake fluid, it can be said that the pressurizing device includes the master cylinder 1 and the servo pressure generation device 4.

To the upstream-side ECU 6, a variety of sensors 71 to 77 are connected. The upstream-side ECU 6 is configured to acquire stroke information, master pressure information, reaction fluid pressure information, servo pressure information, wheel speed information and the like from the sensors. The sensors and the upstream-side ECU 6 are interconnected via a communication line (CAN) (not shown). Also, the upstream-side ECU 6 is configured to acquire information about the control situations (during antiskid control and the like) of the actuator 5 from the downstream-side ECU 6A.

The downstream-side ECU 6A is an ECU configured to execute a control on the actuator 5, based on a target wheel pressure (or a target deceleration) that is a target value of the wheel pressure. The downstream-side ECU 6A is configured to execute the pressure increasing control, the pressure reducing control, the holding control or the pressurization control on the actuator 5, based on the target wheel pressure.

Herein, each control state by the downstream-side ECU 6A is described by taking the control on the wheel cylinder 541 as an example. In the pressure increasing control, the pressure increasing valve 52 (and the differential pressure electromagnetic valve 51) is in the opened state and the pressure reducing valve 54 is in the closed state. In the meantime, the flow of the brake fluid from an upstream toward a downstream is permitted and a backflow thereof is prohibited by the check valve 51b provided in parallel with the differential pressure electromagnetic valve 51. Therefore, when the fluid pressure on the upstream-side is higher than the fluid pressure on the downstream-side, the brake fluid is supplied to the downstream side via the check valve 51a, without the control on the differential pressure electromagnetic valve 51. In the pressure reducing control, the pressure increasing valve 52 is in the closed state and the pressure reducing valve 54 is in the opened state. In the pressure reducing control, the brake fluid can be pumped out from the wheel cylinder 541 by the pump 57.

In the holding control, the pressure increasing valve 52 and the pressure reducing valve 54 are in the closed state. Also, the holding control can be executed by closing (throttling) the pressure reducing valve 54 and the differential pressure electromagnetic valve 51, without closing the pressure increasing valve 52. Also, in the holding control, from a standpoint of pressurization responsiveness, a control of holding the differential pressure is also executed while causing the brake fluid to flow out from the differential pressure electromagnetic valve 51 toward the upstream side, in a state where the electric motor 90 and the pump 57 are being driven. That is, the differential pressure electromagnetic valve 51 and/or the pressure increasing valve 52 can be referred to as a holding electromagnetic valve (holding device) configured to hold the wheel pressure. The pressure increasing valve 52 is provided with a check valve, so that when the wheel pressure becomes higher than a fluid pressure at the branch point X, the brake fluid is caused to flow out toward the branch point X via the check valve. That is, in the pressure increasing valve 52 of the first embodiment, the wheel pressure cannot be held higher than the master pressure. In the meantime, when the differential pressure electromagnetic valve 51 performs the differential pressure control (throttling) in a state where the master pressure and the wheel pressure are the same fluid pressure, the wheel pressure at the time of the differential pressure control is held by the differential pressure, without the drive of the pump 57, even when the master pressure becomes smaller than the wheel pressure. Therefore, in the first embodiment, the differential pressure electromagnetic valve 51 is caused to function as the holding electromagnetic valve, and the pressure increasing valve 52 is closed at the time of the pressure reducing control.

In the pressurization control, the differential pressure electromagnetic valve 51 is in a differential pressure state (throttled state), the pressure increasing valve 52 is in the opened state, the pressure reducing valve 54 is in the closed state, and the electric motor 90 and the pump 57 are driven. The electric motor 90 and the pump 57 can be referred to as a fluid pressure supply part configured to supply the brake fluid to a fluid pressure path for interconnecting the master chamber and the wheel cylinder. Also, the pressure reducing valve 54 can be referred to as a valve configured to reduce the wheel pressure held by the differential pressure electromagnetic valve 51. The actuator 5, the differential pressure electromagnetic valve 51, or the differential pressure electromagnetic valve 51, the pump 57 and the electric motor 90 correspond to “second pressurizing device” configured to control the differential pressure between the master pressure and the wheel pressure as current is supplied thereto. It can be said that the second pressurizing device includes the differential pressure electromagnetic valve 51, the pump 57 configured to supply the brake fluid to the main pipe conduit A for interconnecting the differential pressure electromagnetic valve 51 and the wheel cylinders 541 and 542, and the electric motor 90 configured to drive the pump 57.

To the downstream-side ECU 6A, a variety of sensors such as the stroke sensor 71, the pressure sensors 73 and 77, the wheel speed sensor 76 and the like are connected. The downstream-side ECU 6A is configured to acquire stroke information, master pressure information, reaction fluid pressure information, wheel speed information and the like from the sensors. The diverse sensors and the downstream-side ECU 6A are interconnected via a communication line (not shown). The downstream-side ECU 6A is configured to execute a side slip prevention control and an antiskid control on the actuator 5, in response to situations and requests.

An example of cooperative control of both the ECUs 6 and 6A is briefly described. The upstream-side ECU 6 sets a target deceleration, based on the stroke information, and transmits the target deceleration information to the downstream-side ECU 6A via the communication line. A target master pressure and a target wheel pressure are determined, based on the target deceleration. The upstream-side ECU 6 and the downstream-side ECU 6A control the fluid pressure of the brake fluid by cooperative control so that the wheel pressure is to approach the target wheel pressure (the deceleration is to approach the target deceleration). In the upstream-side ECU 6, the target deceleration is calculated to calculate the target master pressure, based on the stroke, and in the downstream-side ECU 6A, the target wheel pressure is calculated, based on the target deceleration, and a pressurizing amount (control amount) is set, based on the detected master pressure (or the target master pressure) and the target wheel pressure. The downstream-side ECU 6A transmits the control situation (during the antiskid control or the like) to the upstream-side ECU 6. In the meantime, the wheel pressure can be estimated from the master pressure (a detection value of the pressure sensor 77) and the control state of the actuator 5. Also, for example, the wheel cylinders 541 and 544 may be provided with wheel pressure sensors.

(Heat Generation Suppression Control)

In the first embodiment, the control on the master pressure is mainly performed by the servo pressure generation device 4 and the upstream-side ECU 6 and the pressure adjustment is performed in an auxiliary manner by the actuator 5 and the downstream-side ECU 6A, so that the braking force (wheel pressure) is controlled. That is, each of the ECUs 6 and 6A sets the same value for the target master pressure and the target wheel pressure, upon usual control except the specific controls such as an antiskid control, a side slip prevention control and the like. In the usual control, the wheel pressure has the same value as the master pressure.

Herein, the upstream-side ECU 6 and the downstream-side ECU 6A cooperatively execute a heat generation suppression control (which is included in the specific controls) when a prescribed condition is satisfied. Therefore, in the description of the heat generation suppression control, the upstream-side ECU 6 and the downstream-side ECU 6A are referred to as one control device 60. The control device 60 includes, as a function of executing the heat generation suppression control, an acquiring unit 61 and a control unit 62. The acquiring unit 61 is configured to acquire a heat generation correlation value indicative of a heat generation state of the servo pressure generation device 4. When the heat generation correlation value acquired by the acquiring unit 61 is equal to or greater than a prescribed threshold value, the control unit 62 executes a first control of decreasing electric power supplied to the servo pressure generation device 4 (in the first embodiment, the pressure reducing valve 41), and a second control of controlling the actuator 5 (in the first embodiment, the differential pressure electromagnetic valves 51 and 91) so as to compensate for changes in wheel pressures, accompanying the execution of the first control. Here, the acquiring unit 61 of the present embodiment is configured to acquire, as a holding state correlation value, a heat generation correlation value in a state of holding the fluid pressures (master pressures) that are supplied to the wheel cylinders 541 to 544 by the servo pressure generation device 4 (in the first embodiment, the pressure reducing valve 41). The control unit 62 executes the first control and the second control when the holding state correlation value is equal to or greater than the threshold value. In other words, as the heat generation suppression control, when the heat generation correlation value (holding state correlation value) correlating with the heat generation of the pressure reducing valve 41 becomes equal to or greater than the threshold value, the control device 60 reduces the current value supplied to the pressure reducing valve 41 by a prescribed value, as compared to a case where the heat generation correlation value is smaller than the threshold value, and also increases the current value supplied to the differential pressure electromagnetic valves 51 and 91, in accordance with the prescribed value. The degree of increase in control current to the differential pressure electromagnetic valves 51 and 91 is set based on the prescribed value and the target wheel pressure so that the wheel pressure can hold the target wheel pressure.

The heat generation correlation value (holding state correlation value) of the first embodiment is set as a generation duration time of the braking force during a vehicle stop (vehicle speed=0 km/h), i.e., an energization duration time (which can also be referred to as a continuous energization time or a continuous valve closing time) to the pressure reducing valve 41 during the vehicle stop. A relation between the energization duration time to the pressure reducing valve 41 and a heat generation temperature of the pressure reducing valve 41 can be obtained in advance by a calculation or the like, from a change in resistance value of a coil of the pressure reducing valve 41 with respect to the energization time, and the like. The longer the energization duration time to the pressure reducing valve 41 is, or the greater the current value supplied to the pressure reducing valve 41 is, the higher the heat generation temperature of the pressure reducing valve 41 is. The control device 60 executes the heat generation suppression control described above when the energization duration time to the pressure reducing valve 41 during the vehicle stop becomes equal to or longer than a prescribed time. In the meantime, the heat generation correlation value may be an actual temperature of the pressure reducing valve 41 (for example, a detection value of a temperature sensor) or a temperature estimated by a calculation, for example. In this case, the threshold value is the prescribed temperature.

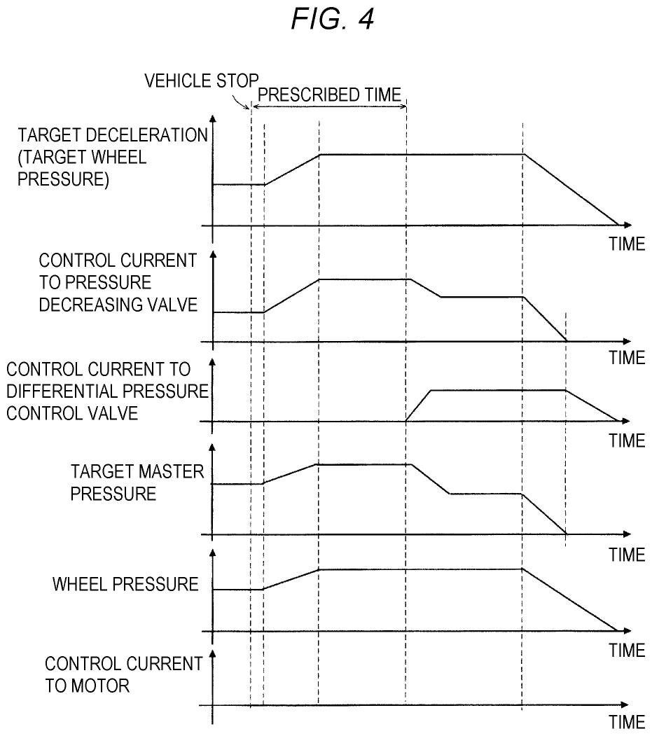

A specific example of the heat generation suppression control is described with reference to FIG. 4. As shown in FIG. 4, in a situation of the specific example, a brake operation is performed to generate a braking force, so that the vehicle is stopped, and after the vehicle stop, the depression on the brake pedal 10 is increased to increase the target deceleration (target wheel pressure). As the target deceleration increases, the target master pressure also increases and the current value (control current value) supplied to the pressure reducing valve 41 also increases. The current value to the pressure reducing valve 41 is increased, so that the pilot pressure can be held at a higher fluid pressure and the servo pressure and the master pressure can be increased. At this time, the actuator 5 is not actuated and the differential pressure electromagnetic valves 51 and 91 are in the communication state (non-energization state).

In the state where the braking force is generated, after the prescribed time elapses since the vehicle stop, the control device 60 reduces the current value supplied to the pressure reducing valve 41 by the prescribed value and increases the current value supplied to the differential pressure electromagnetic valves 51 and 91, in accordance with the prescribed value. That is, the acquiring unit 61 acquires a duration time after the vehicle stop in the control of holding the master pressure to the prescribed pressure or higher (also in the case of the pressure increase, it is assumed that the pressure reducing valve 41 is closed). The control unit 62 executes the first control and the second control when the duration time acquired by the acquiring unit 61 becomes equal to or longer than the prescribed time. At this time, the control unit 62 of the first embodiment executes the increase in current value to the differential pressure electromagnetic valves 51 and 91 (second control) slightly earlier than the decrease in current value to the pressure reducing valve 41 (first control). That is, the control unit 62 executes the first control after executing the second control. In other words, the control device 60 increases the current value supplied to the differential pressure electromagnetic valves 51 and 91, in accordance with the prescribed value, and then reduces the current value supplied to the pressure reducing valve 41 by the prescribed value. Thereby, it is possible to accurately suppress the braking force from being leaked (lowered). In the meantime, the increase and decrease in current value may be executed at the same time.

Also, in the second control, the control unit 62 controls the actuator 5 while assuming an amount of change that is larger than an amount of change in output fluid pressure (master pressure) of the servo pressure generation device 4, accompanying the execution of the first control. In other words, the control unit 62 increases the current value supplied to the differential pressure electromagnetic valves 51 and 91 so that a differential pressure amount, which increases due to the increase in current value supplied to the differential pressure electromagnetic valves 51 and 91, becomes greater than a pressure reducing amount of the master pressure corresponding to the prescribed value. That is, the control unit 62 reduces the control current to the pressure reducing valve 41 to reduce the master pressure by the prescribed pressure, supplies the control current to the differential pressure electromagnetic valves 51 and 91, and increases the control differential pressure from zero (0) to a prescribed differential pressure (prescribed pressure<prescribed differential pressure). Thereby, the control is performed, considering a pressure loss in a state where the pump 57 and the electric motor 90 are not driven, so that the braking force can be accurately suppressed from being leaked (lowered). In the example of FIG. 4, the electric motor 90 is not driven. In the meantime, the prescribed differential pressure may be set to be the same value as the prescribed pressure.

When the brake pedal 10 is released and the target deceleration is thus lowered, the control device 60 reduces the control current to the pressure reducing valve 41 to zero (0), in accordance with the decrease in target deceleration, and then reduces the control current to the differential pressure electromagnetic valves 51 and 91 to zero (0) (differential pressure=0). That is, the control device 60 reduces the control current to the pressure reducing valve 41, in accordance with the decrease in target deceleration (target wheel pressure), and then reduces the control current to the differential pressure electromagnetic valves 51 and 91. The master pressure on the upstream-side is likely to be affected by a mechanical hysteresis, for example. Thus, after first opening the pressure reducing valve 41, the control differential pressure of the differential pressure electromagnetic valves 51 and 91 that can be pressure-adjusted relatively linearly is reduced, so that the wheel pressure can be smoothly reduced. For the control of the wheel pressure by the actuator 5, a dead zone is not required, and the control accuracy is increased, as compared to the upstream-side. The hysteresis (control delay) is caused due to a sliding resistance between a seal member and the control piston 445 of the regulator 44, for example. In the meantime, the decrease in wheel pressure is not limited to the above, and the control device 60 may appropriately reduce the wheel pressure, in accordance with the decrease in target deceleration. Also, when the hysteresis is small, the control device 60 may reduce the control current to the differential pressure electromagnetic valves 51 and 91 to zero (0) (differential pressure=0) and then reduce the control current to the pressure reducing valve 41 to zero (0).

According to the first embodiment, in a situation where the master pressure is held, when the pressure reducing valve 41 generates heat by a threshold value or greater due to the energization, the current (control current) supplied to the pressure reducing valve 41 is reduced by the first control and the current supplied to the differential pressure electromagnetic valves 51 and 91 is increased by the second control. The control current is reduced, so that the heat generation of the pressure reducing valve 41 is suppressed. Also, the current supplied to the differential pressure electromagnetic valves 51 and 91 is increased, so that the decrease in wheel pressure due to the decrease in current supplied to the pressure reducing valve 41 is compensated (i.e., the wheel pressure is held) and the braking force is held. That is, according to the first embodiment, the heat generation of the device due to the supply of electric power, here, the heat generation of the pressure reducing valve 41 due to the supply of current, which is a device configured to hold the fluid pressure, can be suppressed without reducing the braking force. Also, according to the first embodiment, since the differential pressure electromagnetic valves 51 and 91 of the actuator 5 are used, it is possible to achieve the above operational effects without adding a new electromagnetic valve.

Also, the orifice (opening) of the pressure reducing valve 41 is preferably large, from a standpoint of smoothly reducing the master pressure. Therefore, when the orifice is made large, a seal diameter is accordingly increased and the control current required to hold the prescribed fluid pressure is increased. For this reason, the problem of heat generation due to continuous braking is particularly important for the pressure reducing valve 41. In the meantime, the heat generation suppression control is preferably executed when the master pressure is equal to or greater than the prescribed value. Thereby, while suppressing the execution of the heat generation suppression control as much as possible when it is estimated that the heat generation suppression control is not necessary (when the master pressure is low), the heat generation suppression control can be appropriately executed when a possibility of heat generation is actually high (when the master pressure is high).

### Second Embodiment

A vehicle brake device of a second embodiment is different from the first embodiment, in terms of the control method of the control device 60. Therefore, only differences are described, based on the descriptions and drawings of the first embodiment. In the second embodiment, the pressure adjustment is mainly performed by the actuator 5 (corresponding to “the first pressurizing device”, in the second embodiment) and the downstream-side ECU 6A and the control on the master pressure is performed in an auxiliary manner by the servo pressure generation device 4 (corresponding to “the second pressurizing device”, in the second embodiment) and the upstream-side ECU 6, so that the braking force (wheel pressure) is controlled. That is, the control device 60 generates the wheel pressures almost by the pressurization control of the actuator 5 without the assistance (boosting) of the servo pressure generation device 4, in the usual control. In the usual control, the master pressure is a fluid pressure that is mechanically generated by a brake operation (depression force). The target wheel pressure is set in accordance with the stroke, as described above.

In the above configuration, the acquiring unit 61 acquires the heat generation correlation value indicative of the heat generation state of the actuator 5 (here, the differential pressure electromagnetic valves 51 and 91 or the electric motor 90). When the heat generation correlation value acquired by the acquiring unit 61 is equal to or greater than the prescribed threshold value, the control unit 62 executes the first control of decreasing the electric power supplied to the actuator 5 (the differential pressure electromagnetic valves 51 and 91 or the electric motor 90, in the second embodiment), and the second control of controlling the servo pressure generation device 4 so as to compensate for changes in wheel pressures, accompanying the execution of the first control. In other words, as the heat generation suppression control, when the heat generation correlation value correlating with the heat generation of the differential pressure electromagnetic valves 51 and 91 or the electric motor 90 becomes equal to or greater than the threshold value, the control device 60 reduces the current value supplied to the differential pressure electromagnetic valves 51 and 91 or the electric motor 90 by a prescribed value, as compared to a case where the heat generation correlation value is smaller than the threshold value, and also increases the current value supplied to the servo pressure generation device 4 so that the master pressure is to increase, in accordance with the prescribed value. The heat generation correlation value (for example, the holding state correlation value) is set as the energization duration time to the differential pressure electromagnetic valves 51 and 91 or the electric motor 90 after the vehicle stop, like the first embodiment. The current supplied to the differential pressure electromagnetic valves 51 and 91 or the electric motor 90 is reduced, so that the heat generation of the differential pressure electromagnetic valves 51 and 91 or the electric motor 90 is suppressed. Also, the current supplied to the servo pressure generation device 4 is increased, so that the master pressure, which is a basis of the wheel pressure, is increased and the wheel pressure is held. Therefore, also in the second embodiment, the heat generation of the differential pressure electromagnetic valves 51 and 91, which are devices configured to hold the fluid pressure, or the electric motor 90 due to the supply of current can be suppressed without reducing the braking force.

Also, in the second embodiment, focusing on only the heat generation of the electric motor 90, when the heat generation correlation value correlating with the heat generation of the electric motor 90 becomes equal to or greater than the threshold value, the control device 60 may reduce the control current to the electric motor 90 to stop the electric motor 90. Then, the control device may increase the control current to the differential pressure electromagnetic valves 51 and 91 and the servo pressure generation device 4 (for example, the pressure reducing valve 41) to implement the target wheel pressure.

### Third Embodiment

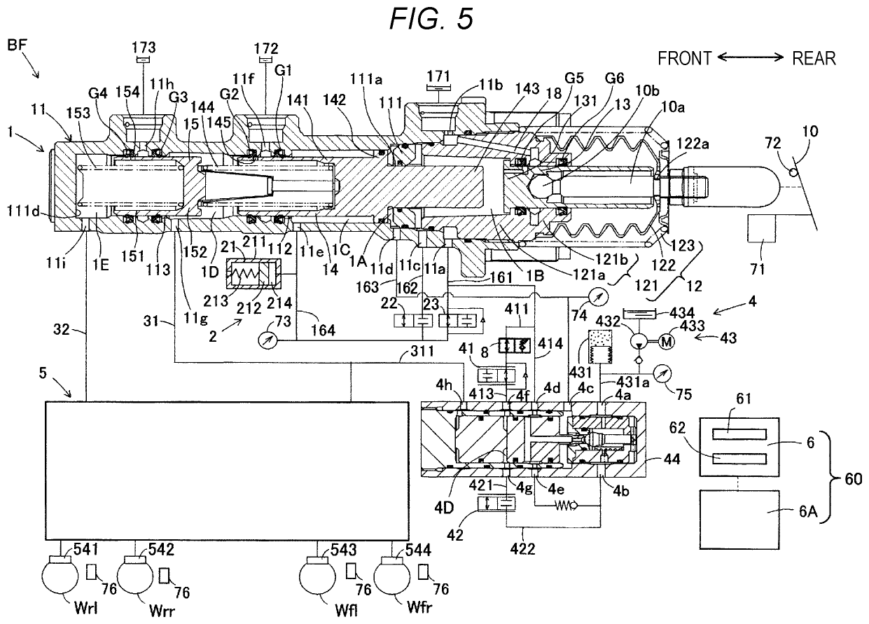

A vehicle brake device of a third embodiment is different from the first embodiment, in terms of the configurations of the vicinity of the pressure reducing valve 41 and the actuator 5. Therefore, only differences are described, based on the descriptions and drawings of the first embodiment and FIG. 5. As shown in FIG. 5, the pressure reducing valve 41 and a holding electromagnetic valve 8 are disposed in series on the pipe (corresponding to “the flow path”) 411 for interconnecting the first pilot chamber 4D and the reservoir 171. That is, the pressurizing device including the servo pressure generation device 4 includes the master cylinder 1, the normally open pressure reducing valve 41 disposed on the pipe 411 for interconnecting the first pilot chamber 4D configured to generate the pilot pressure for driving the master pistons 14 and 15 and the reservoir 171, and the normally open holding electromagnetic valve 8 disposed on a part of the pipe 411 between the pressure reducing valve 41 and the reservoir 171, and is configured so that the pressure reducing valve 41 is closed when holding the pilot pressure. The holding electromagnetic valve 8 is an electromagnetic valve that is actuated to hold the master pressure as current is supplied thereto. The holding electromagnetic valve 8 of the third embodiment has a similar configuration to those of the differential pressure electromagnetic valves 51 and 91 of the first embodiment. That is, the holding electromagnetic valve 8 is an electromagnetic valve that can be controlled so that a fluid pressure on the further pressure reducing valve 41-side of the pipe 411 than the electromagnetic valve becomes higher than a fluid pressure on the further reservoir 171-side than the electromagnetic valve by the differential pressure control amount.

The actuator 5 is not a so-called ESC actuator that can solely pressurize the wheel pressure, like the first embodiment, but is a so-called ABS actuator with no differential pressure electromagnetic valves 51 and 91 and the like. Although not shown, the actuator 5 includes an electromagnetic valve, a pump, and a motor and is configured to execute the antiskid control. The pump can pump out the brake fluid in the wheel cylinders 541 to 544 to the master cylinder 1 upon reduction in pressure, for example.

In the above configuration, the acquiring unit 61 acquires the heat generation correlation value indicative of the heat generation state of the pressure reducing valve 41. When the heat generation correlation value acquired by the acquiring unit 61 is equal to or greater than the prescribed threshold value, the control unit 62 executes the first control of decreasing the electric power supplied to the pressure reducing valve 41, and the second control of controlling the holding electromagnetic valve 8 so as to prevent the change in master pressure, accompanying the execution of the first control. In other words, when the heat generation correlation value correlating with the heat generation of the pressure reducing valve 41 becomes equal to or greater than the threshold value, the control device 60 reduces the current value supplied to the pressure reducing valve 41 by a prescribed value, as compared to a case where the heat generation correlation value is smaller than the threshold value, and also increases the current value supplied to the holding electromagnetic valve 8, in accordance with the prescribed value. The heat generation suppression control can be executed (by replacing the differential pressure electromagnetic valves 51 and 91 with the holding electromagnetic valve 8), as shown in FIG. 4, like the first embodiment. That is, the current supplied to the pressure reducing valve 41 is reduced, so that the heat generation of the pressure reducing valve 41 is suppressed. Also, the current supplied to the holding electromagnetic valve 8 is increased, so that the master pressure is held. Therefore, also in the third embodiment, the heat generation of the pressure reducing valve 41 due to the supply of current, which is a device configured to hold the fluid pressure, can be suppressed without reducing the braking force. In the meantime, the actuator 5 may also be an ESC actuator.

### Others

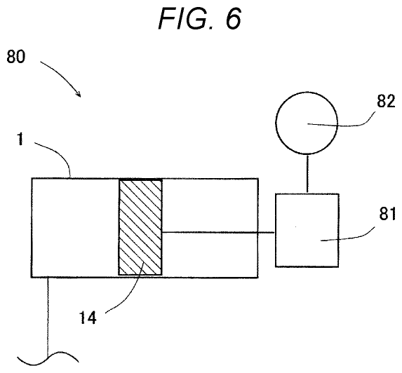

The present invention is not limited to the above embodiments. For example, as shown in FIG. 6, a pressurizing device 80 that is a device replacing the servo pressure generation device 4 of the first embodiment includes the master cylinder 1, and the master piston 14 that is driven by a linear motion mechanism 82 configured to convert a rotating motion by an actuation of an electric motor 81 into a linear motion, and is configured so that the electric motor 81 is actuated when holding the master pressure. The linear motion mechanism 82 is, for example, a ball screw mechanism. In the electric booster, since a reverse efficiency of the linear motion mechanism 82 is high, it is necessary to supply the electric power to the electric motor 81 and to hold the drive force so as to hold the master pressure. Also in this configuration, the acquiring unit 61 acquires a heat generation correlation value (for example, the holding state correlation value) of the pressurizing device 80 (for example, the electric motor 81), and when the heat generation correlation value is equal to or greater than the prescribed threshold value, the control unit 62 executes the first control of decreasing the electric power supplied to the pressurizing device 80 (for example, the electric motor 81), and the second control of controlling the actuator 5 so as to compensate for a change in wheel pressure, accompanying the execution of the first control. Thereby, it is possible to achieve the similar effects to that of the first embodiment.

Also, the heat generation suppression control is not limited to the execution during the vehicle stop. For example, the heat generation suppression control may be set to be executed when the vehicle speed is equal to or lower than a prescribed speed. When a duration time in which the vehicle speed is equal to or lower than a prescribed speed and the master pressure or the wheel pressure is equal to or greater than a prescribed value is equal to or longer than a prescribed time, for example, the control device 60 may execute the heat generation suppression control. The execution during the vehicle stop lowers a possibility that the driver will feel uncomfortable, even though the braking force fluctuates due to the execution of the heat generation suppression control. Also, the present invention can be applied to a hybrid vehicle, a vehicle having an automatic driving function or a vehicle having an automatic brake function, for example. Also, the control device 60 may be configured by one ECU. Also, the servo pressure generation device 4 may have a configuration where the regulator 44 is not provided, for example, a configuration where the pressure reducing valve 41 and the pressure increasing valve 42 are connected to the servo chamber 1A. Also, the hysteresis may occur other than in the regulator 44. Also, the regulator 44 maybe a spool valve type, for example. Also, the target deceleration (target wheel pressure) of FIG. 4 may be replaced with a stroke, so as to deal with the stroke of the brake pedal 10. Also, in the control device 60, the greater prescribed value may be set as the heat generation correlation value is greater. The prescribed value is set for each heat generation target. Also, in the first or second embodiment, the execution of the heat generation suppression control (and/or the determination of the heat generation correlation value) is not limited to upon the holding control, and may be performed at the time of the pressure increasing/reducing control.

1. A vehicle brake device configured to supply a brake fluid pressurized by a first pressurizing device and a second pressurizing device to a wheel cylinder, the vehicle brake device comprising:
an acquiring unit configured to acquire a heat generation correlation value indicative of a heat generation state of the first pressurizing device; and
a control unit that, when the heat generation correlation value acquired by the acquiring unit is equal to or greater than a prescribed threshold value, executes a first control of decreasing electric power supplied to the first pressurizing device, and a second control of controlling the second pressurizing device so as to compensate for a change in wheel pressure that is a fluid pressure inside the wheel cylinder, accompanying the execution of the first control.

2. The vehicle brake device according to claim 1, wherein the control unit is configured to execute the first control after executing the second control.

3. The vehicle brake device according to claim 1,
wherein the first pressurizing device is configured so that electric power is consumed when holding a fluid pressure to be supplied to the wheel cylinder,
wherein the acquiring unit is configured to acquire, as a holding state correlation value, the heat generation correlation value in a state where the first pressurizing device holds the fluid pressure to be supplied to the wheel cylinder, and
wherein when the holding state correlation value is equal to or greater than the threshold value, the control unit executes the first control and the second control.

4. The vehicle brake device according to claim 1, wherein the first pressurizing device comprises a master cylinder, and a normally open pressure adjusting electromagnetic valve configured to adjust inflow and outflow of the brake fluid to and from a drive fluid pressure chamber in which a drive fluid pressure for driving a master piston is generated, and is configured so that the pressure adjusting electromagnetic valve is closed when holding the drive fluid pressure.

5. The vehicle brake device according to claim 1, wherein the first pressurizing device comprises a master cylinder, and a master piston configured to be driven by a linear motion mechanism configured to convert a rotating motion by an actuation of an electric motor into a linear motion, and is configured so that the electric motor is actuated when holding a fluid pressure in the master cylinder.

6. The vehicle brake device according to claim 1, wherein the first pressurizing device comprises a normally open differential pressure electromagnetic valve configured to adjust a differential pressure between an output fluid pressure of the second pressurizing device and the wheel pressure, and a pump configured to discharge a brake fluid between the second pressurizing device and the differential pressure electromagnetic valve to a part between the differential pressure electromagnetic valve and the wheel cylinder.

7. The vehicle brake device according to claim 1,
wherein the second pressurizing device comprises a normally open differential pressure electromagnetic valve configured to adjust a differential pressure between an output fluid pressure of the first pressurizing device and the wheel pressure, and a pump configured to discharge a brake fluid between the first pressurizing device and the differential pressure electromagnetic valve to a part between the differential pressure electromagnetic valve and the wheel cylinder, and
wherein the control unit is configured to control the second pressurizing device in the second control, assuming an amount of change that is larger than an amount of change in output fluid pressure of the first pressurizing device, accompanying the execution of the first control.

8. A vehicle brake device comprising:
a pressurizing device comprising a master cylinder, a normally open pressure adjusting electromagnetic valve disposed on a flow path for interconnecting a drive fluid pressure chamber, in which a drive fluid pressure for driving a master piston is generated, and a reservoir, and a normally open holding electromagnetic valve disposed on a part of the flow path between the pressure adjusting electromagnetic valve and the reservoir, the pressurizing device being configured so that the pressure adjusting electromagnetic valve is closed when holding the drive fluid pressure;
an acquiring unit configured to acquire a heat generation correlation value indicative of a heat generation state of the pressure adjusting electromagnetic valve; and
a control unit that, when the heat generation correlation value acquired by the acquiring unit is equal to or greater than a prescribed threshold value, executes a first control of decreasing electric power supplied to the pressure adjusting electromagnetic valve, and a second control of controlling the holding electromagnetic valve so as to prevent a change in fluid pressure inside the master cylinder, accompanying the execution of the first control.
